(19) United States
(12) Patent Application Publication
(10) Pub. No.: US 2022/0245687 A1
(43) Pub. Date: Aug. 4, 2022

(54) METHOD AND SYSTEM FOR EVALUATING PRODUCT RESEARCH

(71) Applicants: John Andersen, El Cajon, CA (US); Rajiv Saini, Shenandoah, TX (US)

(72) Inventors: John Andersen, El Cajon, CA (US); Rajiv Saini, Shenandoah, TX (US)

(21) Appl. No.: 17/610,117

(22) PCT Filed: Jun. 22, 2020
(86) PCT No.: PCT/US20/38980

§ 371 Date: Nov. 9, 2021

Related U.S. Application Data
(60) Provisional application No. 62/864,557, filed on Jun. 21, 2019.

(51) Int. Cl. G06Q 30/02

(52) U.S. Cl. CPC G06Q 30/0282

(57) ABSTRACT

Systems and methods for evaluating product research are disclosed herein. A user inputs product information to a website or app, after which a database is searched for documentation related to the product. This documentation is scanned for the answers to questions related to the product. Based on these answers, a unique score is generated that is indicative of the quality of the product research. The score provides consumers and companies a novel critical and dynamic analysis of the quality of research used to market a product, allowing consumers to become empowered to ask questions about a product from their healthcare provider or product supplier.

### CROSS-REFERENCE TO RELATED APPLICATIONS

This application claims priority from U.S. Provisional Application Ser. No. 62/864,557 filed on Jun. 21, 2019, and PCT Patent Application Serial Number PCT/US2020/038980 filed on Jun. 22, 2020, which are incorporated herein by reference in their entirety.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### FIELD

The present teachings relate to methods and systems for evaluating product research by assigning a unique score based on information about the product.

### INTRODUCTION

While peer reviewed journal articles are the gold standard for research, companies often release their own studies that are favorable to them, omitting damning data. Properly conducted, good quality research is expensive and time consuming; omitting steps can reduce costs and/or speed up results. Research for medical, dental, and veterinary products is no exception. The media is filled with stories of litigation related to a product's negative side effects, and the vast majority of these issues are easily traceable to poorly structured clinical research. Not knowing what research to trust is a major issue for consumers. It is important for the public to understand the complexities surrounding what constitutes quality research, since companies use research claims to market their products.

### SUMMARY

The present teachings include a method for assessing a product's research quality. A computing device, like a laptop, iPad, desktop, or smartphone, receives data from a user; the data having to do with a company's product. Consumer product name, scanning of a product's barcode, or other product information may be data inputted by the user. The inputted data triggers access to a database comprised of information related to the data. An algorithm is deployed for searching the database for product descriptors related to the inputted data. The result of this search is then compared to a first standard. The National Institute of Health (NIH) guidelines may be the first standard. The result of the algorithm mining the database and the data being compared to a first standard is the generation of a unique score, with the score being an indicator of the caliber of the product research.

In accordance with a further aspect, the database contains information such as journal articles, abstracts, white papers, clinical research papers, and case studies. Other product collateral may also be contained in the database.

In accordance with yet a further aspect, the unique score comprises a clinical research quality index analysis (CRQIA) score, a research quality score, and a rating. The CRQIA score, research quality score, and rating are all correlated. For instance, a CRQIA score of 30 correlates to a research quality score of Excellent, which is correlated to a rating of 5.

In accordance with yet a further aspect, the product descriptors used for CRQIA analysis include study type, study center, principal author affiliation, number of subjects enrolled, positive and negative controls, study duration, number of investigators, number of centers involved, and study protocol.

In accordance with yet a further aspect, applying the algorithm involves comparing the items in the database associated with the inputted data with a first standard, such as the NIH guidelines, and a second standard, such as other research guidelines, to determine if the database items meet these guidelines. The database items are then run through a set of questions to assess the caliber of the database items and generate a CRQIA score.

In accordance with yet a further aspect, a server connects a website that a user may access to input product data. A mobile application may also be used by a user to input the product data.

In accordance with yet a further aspect, the database is continuously updated with more product information.

In accordance with yet a further aspect, users and companies may upload product content to the website and mobile application. The content eventually is deposited into the database and will be used for generating the unique score.

In accordance with yet a further aspect, the user or company receives the unique score in real time after inputting product data.

In accordance with yet a further aspect, the user or company receives the unique score after a time delay, as time may be needed to calculate the unique score.

In accordance with yet a further aspect, the CRQIA score, product quality score, and rating are depicted pictorially or graphically on the website or mobile application.

The present teachings also teach a system for assessing quality research. The systems comprises a server and a computing device. The computing device, such as a laptop, desktop, iPad, or smartphone, communicates with the server via a network. The computing device also comprises a processor and memory. The memory has executable code that receives data into the computing device, accessing a database with documents related to the inputted data, applying an algorithm that mines the database for product descriptors associated with the inputted data, comparing the results of the mining to a first standard, and generating a unique score that is shown on a graphical user interface of the computing device. The data is typically product name, a scanning of a product's barcode, or other product information.

In accordance with a further aspect, the database contains information such as journal articles, abstracts, clinical research papers, white papers, and case studies. Other product information may also be included in the database.

In accordance with yet a further aspect, the unique score is comprised of a CRQIA score, a research quality score, and a rating, all of which are correlated to each other.

In accordance with yet a further aspect, the product descriptors are study type, study center, principal author affiliation, number of subjects enrolled, positive and negative controls, study duration, number of investigators, number of centers involved, and study protocol.

In accordance with yet a further aspect, the algorithm involves comparing the items in the database with a first standard, such as the NIH guidelines, and a second standard, such as research guidelines from other reputable bodies, to determine if the database items meet these guidelines.

In accordance with yet a further aspect, the server connects a website or a mobile application so that one has the option of using various types of computing devices to obtain the unique score.

In accordance with yet a further aspect, the database in the system continuously accepts publications, which may update the unique score.

In accordance with yet a further aspect, a user or company may upload content to the website or mobile application, which may update the unique score.

In accordance with yet a further aspect, the user or company receives the unique score in real time.

In accordance with yet a further aspect, the user or company receives the unique score after a time delay, as it may take some time to calculate the unique score.

In accordance with yet a further aspect, the information in the database comes from a variety of sources, including search engines, scientific literature, patent literature, product websites, and company websites.

The present teachings also teach a computer program product that is comprised of executable code in a non-transitory computer readable medium. A computing device executes the product via a computing device receiving data, after which a database with information related to the inputted data is accessed. The information is mined for product descriptors associated with the inputted data, and the information is compared with a first standard such as NIH guidelines. The final result is a unique score that is shown on the graphical user interface of the computing device.

In accordance with a further aspect, the database contains journal articles, abstracts, clinical research papers, white papers, and case studies. Other types of documentation are also possible to be contained in the database.

In accordance with yet a further aspect, the unique score is comprised of a CRQIA score, a research quality score, and a rating.

In accordance with yet a further aspect, the product descriptors are study type, study center, principal author affiliation, number of subjects enrolled, positive and negative controls, study duration, number of investigators, number of centers involved, and study protocol.

In accordance with yet a further aspect, applying the algorithm involves comparing the items in the database associated with the inputted data with a first standard, such as the NIH guidelines, and a second standard, such as other research guidelines, to determine if the database items meet these guidelines. The database items are then run through a set of questions to assess the caliber of the database items and generate a CRQIA score.

In accordance with yet a further aspect, the server connects a website and mobile application so that either modality may be used to receive the unique score.

In accordance with yet a further aspect, the database may continuously accept product documentation, updating the unique score.

In accordance with yet a further aspect, users or companies may upload documentation to the website or mobile application, updating the unique score of any given search.

In accordance with yet a further aspect, the user or company receives the unique score in real time.

In accordance with yet a further aspect, the user or company receives the unique score after a time delay.

In accordance with yet a further aspect, the documentation in the database may come from sources such as search engines, patent literature, scientific literature, product websites, and company websites.

These and other features, aspects, and advantages of the present teachings will become better understood with reference to the following description, examples and appended claims.

### DRAWINGS

Those of skill in the art will understand that the drawings, described below, are for illustrative purposes only. The drawings are not intended to limit the scope of the present teachings in any way.

FIG. 1 depicts traditional research steps involved in releasing a product to market.

FIG. 2 depicts a device for implementing the flowcharts and generating the outputs of the systems and methods herein.

FIG. 3 depicts a computing environment for evaluating the credibility and quality of clinical research of a product.

FIG. 4 depicts a flowchart for evaluating the credibility and quality of clinical research or a product.

FIG. 5 depicts a flowchart for implementing an algorithm for generating a score directed to assessing and evaluating the credibility and quality of clinical research of a product.

FIG. 6 depicts a flowchart for determining Clinical Research Quality Index Analysis (CRQIA) using the systems and methods herein.

FIG. 7 depicts a flowchart for updating a score directed to assessing and evaluating the credibility and quality of clinical research of a product.

FIGS. 8-11 depict an output of the score in a graphical user interface.

### DETAILED DESCRIPTION

The invention discloses systems and methods directed web-based solutions (e.g., (www.sciencetally.com)) for evaluating a product's clinical research. A unique score is presented as an output to user or a company, wherein the unique score is based on search and analysis results. The methods and systems compare National Institute of Health (NIH) guidelines to research and other collateral related to a product to deem whether this research meets generally accepted standards.

Aspects of the present teachings may be further understood in light of the following Figures, which should not be construed as limiting the scope of the present teachings in any way.

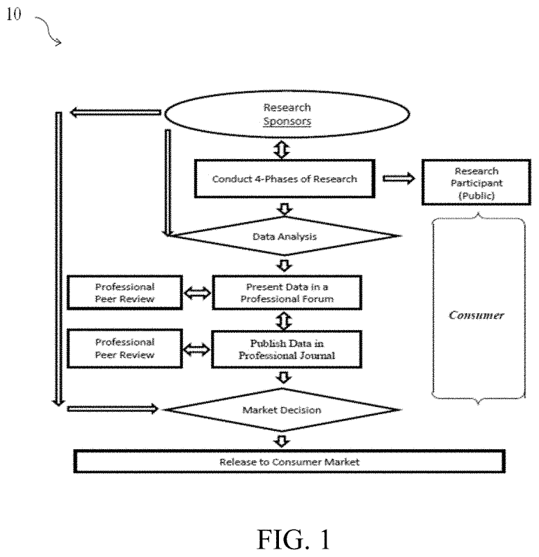

As shown in FIG. 1, a company should follow these steps 10 to produce credible and quality research. Peer review is typically required for research to be deemed compelling and trustworthy. Ideally, research on a company's products has gone through rigorous phases of research, following by presentation of the research at an appropriate forum and publication in a peer-reviewed journal article. Only then should a product be released to the market.

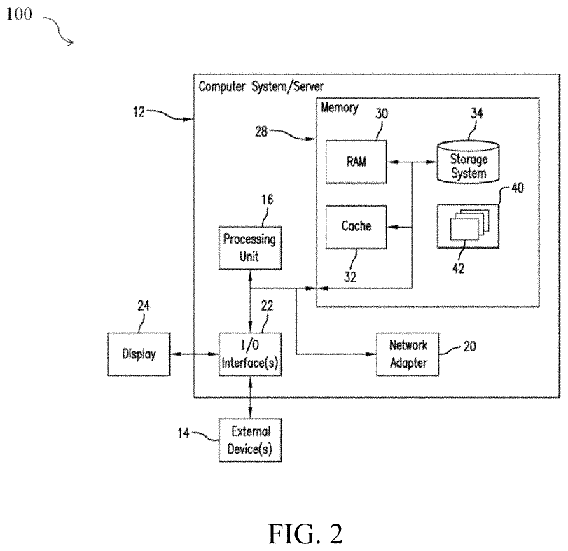

As shown in FIG. 2, computer system/server 12 is shown in the form of a general-purpose computing device 100. The components of computer system/server 12 may include, but are not limited to, one or more processors or processing units 16, a system memory 28, and a bus that couples various system components including system memory 28 to processor 16.

The bus represents one or more of any of several types of bus structures, including a memory bus or memory controller, a peripheral bus, an accelerated graphics port, and a processor or local bus using any of a variety of bus architectures. By way of example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 (a keyboard, a pointing device, a display 24, etc.), one or more devices that enable a user to interact with computer system/server 12, and/or any devices (e.g., network card, modem, etc.) that enable computer system/server 12 to communicate with one or more other computing devices 100. Such communication can occur via Input/Output (I/O) interfaces 22. Still yet, computer system/server 12 can communicate with one or more networks such as a local area network (LAN), a general wide area network (WAN), and/or a public network (e.g. internet) via network adapter 20. A network adapter 20 communicates with the other components of computer system/server 12 via bus 18. It should be understood that, although not shown, other hardware and/or software components could be used in conjunction with computer system/server 12. Examples, include, but are not limited to: microcode, device drivers, redundant processing units, external disk drive arrays, RAID systems, tape drives, and data archival storage systems.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical applications, or technical improvement over technologies found in the marketplace, or to enable others of ordinary skill in the art to understand the embodiments disclosed herein.

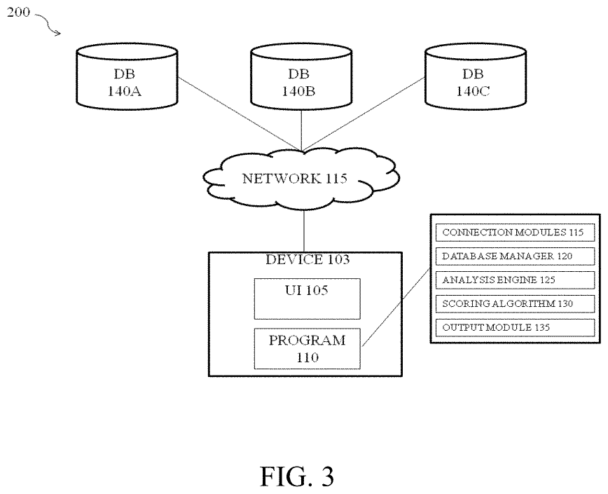

In FIG. 3, an environment 200 depicts a consumer-industry connected technology system for assessment of both the quality of research through real time data analysis and evaluation. Device 103 can include: user interface (UI) 105 (e.g., a monitor or touch screen of a mobile device or computer) and program 110. Network 115 can connect program 110 to database 140A-C via internet connection or any appropriate telecommunication method. Connection modules 115 in program 110 can be application programming interfaces (APIs) that connect to databases 140A-C. Databases 140A-C are connected to network 115. There may be more or less than the three databases in FIG. 3. Unstructured and structured text, image, and video data maybe contained within databases 140A-C. Benefits for the consumer using program 110 can include direct access to research results in an understandable format. Companies that have invested into quality research and documented it well will score better than those companies that have not.

To this end, a database, such as database manager 120, and search algorithms such as analysis engine 125, are applied by program 110. A formula can be created by program 110 to evaluate the data from other databases 140A-C and present it in a simplified consumer friendly format in UI 105. Access to this data from database 140A-C can be in the form of a website and complimentary app that allows immediate scientific product comparison and evaluation either at home or point of purchase. Consumers can create an account so as to get research updates on products as they are available. Companies may register to gain marketing information about whom is reviewing their product research and they may also upload additional research.

Everyday around the world new health products enter into the market. Scientific validation in the form of clinical research is often associated with these new market entrants. Companies use clinical research to validate product effectiveness and understand its side effects. Clinical research may involve a comparison with either placebo or a positive control. The positive controls may be an accepted industry standard product/treatment or a competitor's product.

Sometimes clinical research is associated with project funding either from taxpayer sources or private enterprise. Regardless of the reason, there is a tremendous amount of research data available if one can locate it and understand it. While the internet has provided connectivity to databases 140A-C through network 115, understanding of this hidden knowledge is obscured without program 110.

The modern mobile and internet connected consumer can seek 3rd party validation using program 110. Presently this validation is usually sought in the form of an expert review (i.e., Professional Magazine) or a consumer review (i.e., Amazon.com). Without program 110, the professional publication may access selected research as a basis for a publication and the data retrieved from databases 140A-C can be selective in order to convey the message of the article. The results in: (i) the purpose of the professional article emphasizes a particular point of view while: (ii) not provide the reader with an overall assessment of the research topic available in terms of what is real and what is exaggerated.

The now common consumer review is just an opinion in a scientifically undisciplined environment. Consumers while more dependent upon reviews than ever before are beginning to understand that it is just a personal opinion and possibly a fake. Nielsen Media Corp has determined that consumers value expert validation more than personal reviews in their purchase decision. With regard to clinical research, the consumer is entirely dependent upon the information they receive from a company's website or through a Google search with the complexity of marketing, advertising, technical presentation, and understanding of the research data.

To develop the first time real time science assessment system, program 110 can instantly assess the research (i.e., the CRQIA score directed to the quality of research) and analyzes the science behind the product (i.e., the item of interest). Program 110 is a technology-based system for evaluating the Clinical Research Quality Index Analysis (CRQIA) of a product. CRQIA Index is an algorithm implemented (i.e., applied criteria) by program 110 that provides detailed analysis of many different dimensions of the quality of research. For example, program 110 can use machine learning (ML) techniques to generate models for forming and modifying the search algorithms, such as analysis engine 125. When forming the models, the criterion is established by training against clinical products and clinical publications deemed to be of high quality and reliable (e.g., reproducible results, surveys/studies done across representative populations, and results conforming principles of chemistry and other scientific disciplines). The criteria in this example are focused on reproducibility and representativeness of surveys or studies. The trained models subsequently perform analysis of clinical products or clinical publications directed to the clinical products of interest.

Deficiencies in the research within clinical products or clinical publications directed to the clinical products of interest can be identified by program 115 by comparing to the trained model. More specifically, the model is trained against clinical publications where the surveys are done across a diverse group of people based on pathology, regions of residence, income status, and other factors. If four of the five clinical publications directed to the clinical products of interest only include the number of people getting surveyed without any other information about these people, program 110 flags the four of the five clinical publications directed to the clinical product of interest as factors which lower the quality of research.

The ML techniques can be trained to focus on other factors to provide increasingly nuances analysis when generating a score. For example, the trained model searches for trends within the contents of databases 140A-C. A seminal finding with respect to mouth wash A is published in 2019, which is deemed to be most reputable study pertaining to mouth wash A. Program 110 uses analysis engine 125 to identify differences between the seminal finding published in 2019, publications prior to the seminal finding published in 2019, and publications after the seminal finding published in 2019, thereby refining the model. Further, program 110 focuses on a first set of publications after the seminal finding published in 2019, which are more in tune with the seminal finding published in 2019 than publications prior to the seminal finding published in 2019. Simultaneously, program 110 focuses on a second set of publications after the seminal finding published in 2019 which are less in tune with the seminal finding published in 2019 than publications prior to the seminal finding published in 2019. In turn, the applied criterion is also modified, which increases the CRQIA score for an item of interest which accords more with the first set than the second set; or decreases the CRQIA score of the item of interest which accords more with the second set than the first set.

The ML techniques herein use neural network(s). The neural network(s) can include any combination of neural networks including, but not limited to, Perception Neural Network, Feed Forward Neural Network, Artificial Neuron, Deep Feed Forward Neural Network, Radial Basis Function Neural Network, Recurrent Neural Network, Long/Short Term Memory, Gated Recurrent Unit, Auto Encoder Neural Network, Variation AE Neural Network, Demising AE Neural Network, Sparse AE Neural Network, Markov Chain Neural Network, Modular Neural Network, Hopfield Network, Boltzmann Machine, Restricted BM Neural Network, Deep Belief Network, Deep Convolution Network, Deconvolutional Network, Deep Convolution Inverse Graphics Network, Generative Adversarial Network, Liquid State Machine Neural Network, Extreme Learning Machine Neural Network, Echo State Network, Deep Residual Network, Kohonen Self Organizing Neural Network, Support Vector Machine Neural Network, Neural Turing Machine Neural Network, Convolution Neural Networks such as LeNet, AlexNet, ZF Net, GoogLeNet, VGG Net, Microsoft ResNet, and Region Based CNNs including, but not limited to, Fast R-CNN, Faster R-CNN, R-FCN, Multibox, SSD, and YOLO, amongst others which are known to those of skill in the art.

Criteria, as applied by analysis engine 125, can be modified by the ML techniques above or unaltered. Thus the program 110 is able to implement dynamic analysis and static analysis, respectively. Additionally, the criteria can evolve with societal needs, cultural attitudes, and international laws, which are reflected in questions (as described below). Modifications to the information in databases 140A-C can update the score or the CRQIA using program 110. The CRQIA Index is also correlated a research quality score and a rating, which can be depicted pictorially or graphically.

In turn, program 110 can provide an assessment of quality of research with: (i) corporate benefits; (ii) dental and medical practice benefits; and (iii) consumer benefits. Corporate benefits can include: (a) improved public perception of products through corporate data upload; (b) collection in consumer purchasing behavior data; (c) determination of which products consumers are comparing against another company; and (d) point of sale opportunities. Dental and medical practice benefits can include: (a) better defense against “Direct-to-Consumer Advertising” (DTCPA) questions; (b) cutting through the hype of marketing claims; (c) understanding a products real performance which enables a better more informed choice; (d) improved patient care outcomes; and (e) increased credibility with patients. Consumer benefits include: (a) providing consumer with unprecedented knowledge (i.e., information and findings not previously known to consumers); (b) providing informed choices that do not rely on biased marketing claims; (c) better healthcare choices; (d) improved health care outcomes; (e) point of sale product comparisons; and (f) potential point of sale discount coupons.

Additionally, the quality index can be the Performance Index that conveys to the consumer whether the product was successful in the clinical research evaluation. In other words, program 110 can determine whether the product did what was intended.

Program 110 can evaluate the quality of research for products in a simplified yet understandable manner, and thereby simplifying a complex task. As such, a scoreboard of variables can be weighted to different magnitudes using scoring algorithm 130.

Program 110 can connect the consumers (e.g., users of device 103) with the clinical research and study statistics behind the marketed medical, dental, and veterinary products available commercially. Program 110 can retrieve the clinical research data from the publically accessible domain in databases 140A-C. The contents of databases 140A-C contain information and data deriving from: (i) product website; (ii) company source; (iii) search engines (e.g., Yahoo and Google); (iv) scientific and patent literature searchable using Google Scholar, other scientific platforms available/accessible in public domain, or any other scientific platform.

The product can be first registered in database manager 120 of program 110 with following details: product commercial name; company name; and bar code of product.

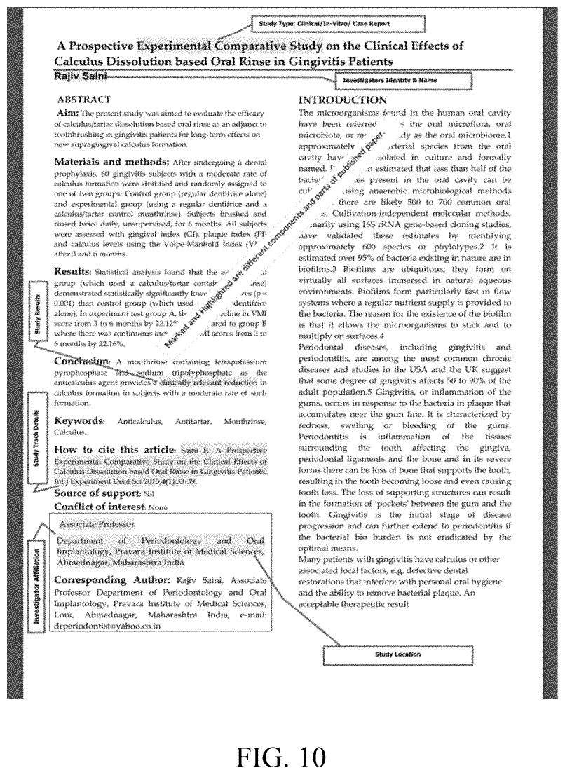

The data, as mentioned above, can be retrieved by program 110 from the clinical research (Published/Unpublished) and updated continuously. Analysis engine 125, as trained via ML, is applied by program 110 to perform different assessment types. Stated another way, certain aspects are focused on by program 110 by retrieving details from the abstract of a study (for granular analysis), the whole research paper/study structure (for complete analysis), and miscellaneous factors (e.g., reputation of the journal and H-index of the author/investigator). Program 110 can send the retrieved values to databases and organize these retrieved values based on category—granular analysis, complete analysis, and miscellaneous factors. Analysis engine 125 may be trained to focus on the following retrieved values when assessing the quality of research (i.e., the CRQIA score): Title of the Study; Duration of the study; Type or research; Author/Investigator name; Study Center; Study Location; Published Year; Study Results; Study Control; Abstract Number; and Journal Name. The focused on areas can be highlighted and send to a UI 105 as an output, as depicted in FIG. 10.

Program 110, which generates CRQIA scores based on the applied criteria by applying analysis engine 125, can identify deficiencies and inconsistencies in the item of interest and the research publication directed to the item of interest. Scoring algorithm 130 in combination with analysis engine 125 identify the factors which increase the CRQIA score (i.e., have a positive effect on the score), decrease the CRQIA score (i.e., have a negative effect on the score), and keep the CRQIA score the same (i.e., have no effect on the score). For example, a research publication makes a claim that a novel plaque removing solution eliminates halitosis. The applied criterion is trained to focus on the credibility of the author and the specifics of the disclosed studies in the research publication. Program 110 notes that the research paper of this example does not have any quantifiable data supporting the claim and the author is not affiliated with a research university. Based on the applied criteria, program 110 can provide a suggestion as an output indicating that a reliable source has quantifiable data as determined and authored by an investigator affiliated with a research university. The manufacturer of the novel plaque removing solution can use the suggestion to improve upon the solution and devise experiments which support the claim of eliminating halitosis.

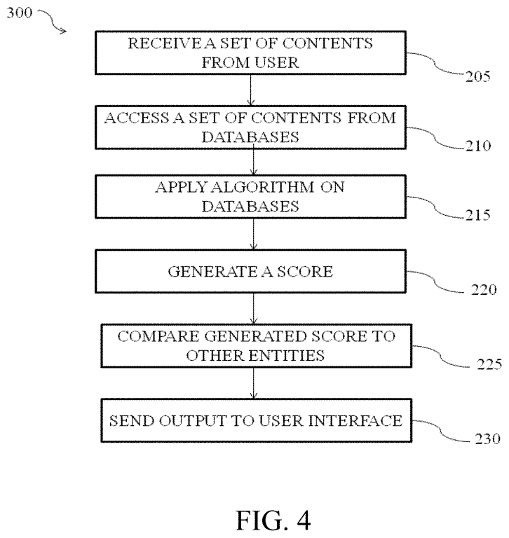

FIG. 4 shows a flowchart 300 identifying the steps in rating research. In step 205, the program 110 receives a set of contents from a user. The contents can include, but are not limited to, a product name, product bar code, and a company name, which can be obtained from device 103. Step 210 involves the program 110 accessing contents from a database; the contents can be publications like journal articles, white papers, case studies, copy from company websites, and other documentation associated with a product. Any user can upload publications to go into the database. In step 215, the program 110 applies the data mining algorithm to the publications identified in the database. The algorithm is mining for product descriptors associated with the contents entered. In step 220, a unique score is generated based on the algorithm search results (i.e., applied criteria of program 110), and the results compared with other entitles, as shown in step 225. Thereby, program 110 can generate a set of standards for assessing the quality of research or item of interest which is distinct in comparison to a set of standards applied by other entities. Other entities include, but are not limited to, a competitor's product literature, an NIH standard, or other scholarly and/or industry standards. Program 110 can generate a score based on the set of standards applied by the other entities, which is used as a point of comparison to the unique score, based on the generated set of standards (deriving from the applied criteria). In step 230, the output (e.g., the unique CRQIA score) is sent to the user interface; the user interface can be associated with a website, a mobile application, or other interface that can display data visually.

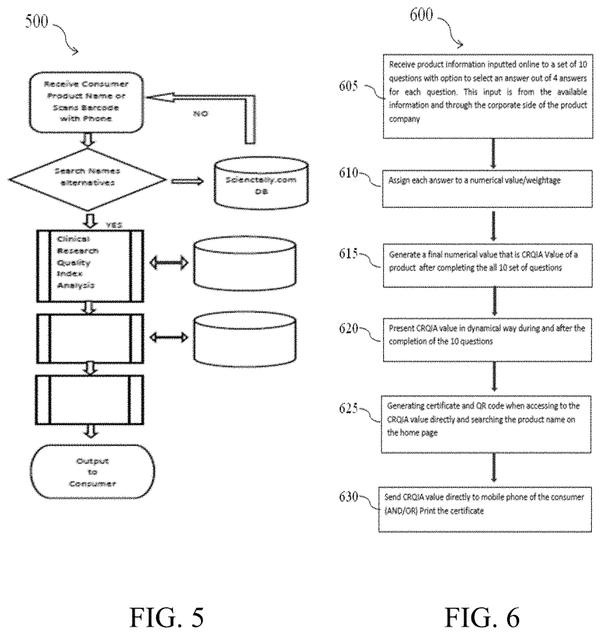

FIG. 5 is a flowchart 500 that outlines the process for the program 110 generating the CRQIA score. As shown in the figure, a product code can be scanned by a smartphone as well as a product name can be entered. The CRQIA score can be correlated to a rating and a research quality score, all of which can be presented to a user visually. CRQIA can be 50% of the score based on the following: study type; study center; principal author affiliation; number of subjects enrolled in the study (large group population study or smaller group population); comparable with positive or negative control (competing product is active product or placebo); duration of the study (small period or longer observation); parameters assessed (number of parameters assessed in the study is a single parameter or multiple parameters); number of investigators involved (number of investigators working in the study is a single investigator or multiple investigators); number of centers involved (a single center or multiple center study); and study protocol (assessing the solo product in focus or combination of products). Research significance is the remaining 50% of the overall rating.

FIG. 6 shows a flowchart 600 that outlines the generation of CRQIA score. Step 605 is, upon the entering of product name, company name, or product bar code, being prompted to answer 10 questions, with each question having four 0 options as answers. With step 610, the program 110 assigns each answer a numerical value. The program 110, in step 615, generates the CRQIA score. This value can also be correlated to a research quality score and a rating. For Step 620, the CRQIA is displayed in a dynamical way. The dynamical way can be visual and readily identified by a user. In Step 625, a certificate and QR (quick response) code is generated, which can subsequently be referred to by a user or company. For Step 630, CRQIA is sent to the user; there is also an option to print the certificate generated in Step 625.

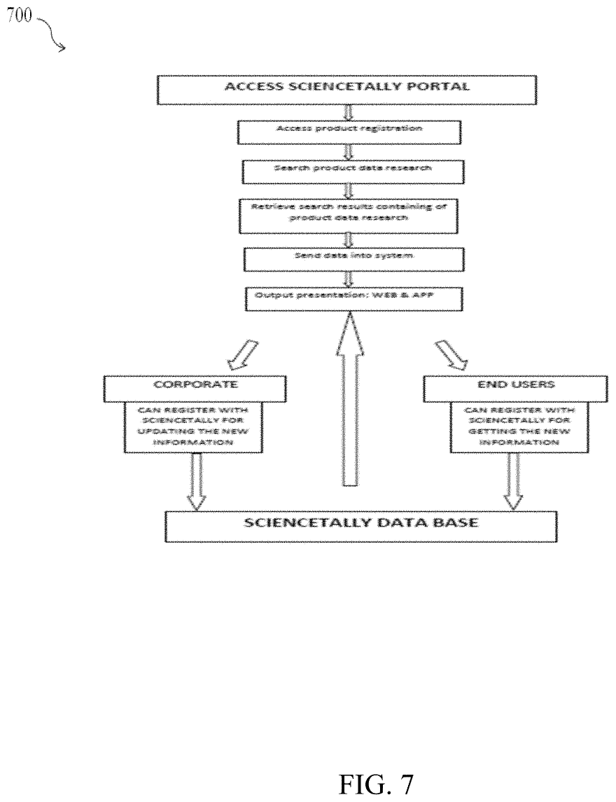

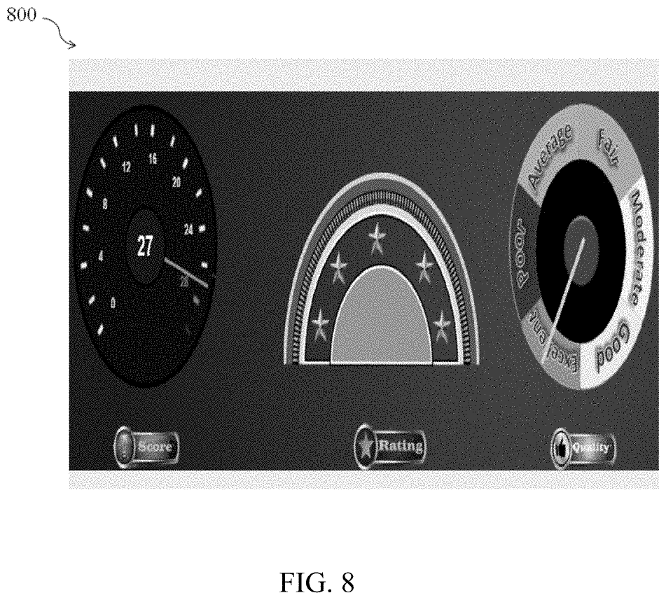

FIG. 7 is a flowchart 700 that shows how a company user and end user interact differently with the program 110. As shown in the figure, the company user can register to update information, namely entering data to be entered into the database. Data can take the form of journal articles, white papers, case studies, and other publications associated with the company's product. An end user can also register to receive updated information as it becomes available.

### EXAMPLES

Aspects of the present teachings may be further understood in light of the following examples, which should not be construed as limiting the scope of the present teachings in any way.

### Example 1—Clinical Research Quality Index Analysis (CRQIA)

CRQIA can be a tool and novel formula where program 110 receives the different research parameters of a product to get the quality analysis of the product through a pre-defined set of questions. In an example, each of the 10 questions can be assigned to numerical value/weighting based on response about the information about the product. The cumulative numerical value of the 10 answers for a product can give the complete clinical research quality index analysis (CRQIA) of the product in a numerical number with a scale ranging from 0-30. According to the CRQIA scoring, program 110 can categorize the research quality from Poor to Excellent. In other example, different questions and a different number of questions can be preconfigured without departing from the scope of the claims. In this example, Table 1 shows the ten questions analyzed by program 110 using analysis engine 125 to generate a unique score using scoring algorithm 130. The CRQIA score is determined by the sum of the answer values. Table 2 shows the correlation of the product's research quality score and the rating to the CRQIA score. While the answer values range from 0-3, other values can be used instead. The research quality score and ratings rubrics may also be replaced with others. There may be instances where these 10 questions cannot be answered or assessed by program 110. In these instances, program 110 may generate a lower rating for the quality of research for those products. Criterion, as described above, is reflected in the questions when assessing the quality of research of products. Further, the criterion can be modified with changing attitudes of societies and changing laws. For example, animal testing is sometimes a pivotal aspect of product testing. Some jurisdictions, animal testing is frowned upon due to societal attitudes or even illegal. In turn, the criterion can be then be modified and thus reflected in a question to assess if the animal testing was involved. If animal testing is involved, then the rating generated by program 110 can decrease. In contrast, the rating generated by program 110 did not decrease when animal testing is involved prior to modifying the criterion. Additionally, the criterion as reflected in the questions can be used to ascertain reproducibility in questions 4-9, which are directed to safety trials of a product, clinical research studies, scientific publications, and scientific presentations. Instances indicative of reproducibility can weigh in favor of program 110 generating a high rating.

TABLE 1
Questions to Generate the Unique Score

| Question | Answer options | Answer value |
|---|---|---|
| What is the product’s patent | Patented | 3 |
| status? | Patent expired | 2 |
| | Patent pending/applied | 1 |
| | Not patented | 0 |
| What is the product’s | Both FDA and Professional | 3 |
| regulatory status? | Association Approved | |
| | Either FDA or Professional | 2 |
| | Association Approved (Like | |
| | ADA, FDI etc.) | |
| | Regulatory Approvals | 1 |
| | Applied/Pending | |
| | No Regulatory Approvals | 0 |
| What is the product's focus | Prevention | 3 |
| category? | Diagnosis | 2 |
| | Treatment | 1 |
| | Not specific | 0 |
| What is the safety and | Both Independent | 3 |
| quality of the product? | Laboratory & | |
| | Clinical Studies confirmed | |
| | safety | |
| | Either Independently | 2 |
| | Laboratory OR Clinical | |
| | Studies confirmed safe | |
| | In House Tested and | 1 |
| | confirmed safe | |
| | Not tested | 0 |
| What is the product’s clinical | Clinical Research Studies | 3 |
| research status | Completed | |
| (university/independent | Clinical Research Studies | 2 |
| research center)? | Ongoing | |
| | Professional Testimonials | 1 |
| | Only | |
| | No Clinical Research | 0 |
| | Completed | |
| What types of clinical | Both National and | 3 |
| research studies were | International Multi Centric | |
| performed for the product? | Research Studies [ | |
| | International Research Only | 2 |
| | (Outside Country of | |
| | company registration) | |
| | National Research Only | 1 |
| | (Country of company | |
| | registration) | |
| | No Research Studies | 0 |
| | (International/National) | |
| How many clinical research | 5-7 | 3 |
| studies for the product have | 3-5 | 2 |
| been completed? | 1-3 | 1 |
| | 0 | 0 |
| How many scientific | 5-7 | 3 |
| research publications in peer | 3-5 | 2 |
| reviewed journals are there | 1-3 | 1 |
| for the product? | 0 | 0 |
| How many scientific | 5-7 | 3 |
| presentations at international | 3-5 | 2 |
| and national congresses have | 1-3 | 1 |
| there been for the product? | 0 | 0 |
| How long has the product | 5-7 years | 3 |
| been commercially | 3-5 years | 2 |
| available? | 1-3 years | 1 |
| | 0-1 years | 0 |

TABLE 2
Correlation of CRQIA Score to
Research Quality Score and Rating

| SCORING | RESEARCH QUALITY | RATING |
|---|---|---|
| 26-30 | Excellent | 5 |
| 21-25 | Good | 4 |
| 16-20 | Moderate | 3 |
| 11-15 | Fair | 2 |
| 6-10 | Average | 1 |
| 1-5 | Poor | 0 |

### Example 2—CRQIA Rating System

As indicated above, understanding the complexities of clinical research papers and products can be difficult for consumers. Oftentimes, pertinent information is contained within esoteric research papers not readily available or understood by the consumer community. Program 110 through analysis engine 125 and scoring algorithm 130 provides CRQIA rating system to consumers. Program 110 uses mathematical corrections and correlation and computer coded technology to calculate the rating of 0 stars, 1 star, 2 star, 3 star, 4 star, and 5 star ratings. Published clinical data studies of products in databases (DB) 140A-C are analyzed by program 110 via analysis engine 125, where: DB 140A is Google Search, DB 140B is Google Scholar, and DB 140C is a corporate website. In this example, four categories are jointly evaluated for research quality and research output of the published study—study type (clinical, in-vitro, or case report); study center (university, independent, corporate, or not identified); affiliation of primary author/investigator (university, independent, corporate, and not identified); and study results (significant or non-significant). Program 110 can identify these categories while also highlighting these categories in the publication, as depicted in FIG. 10. Based on the values for the categories, program 110 generates a star rating. A study type which is clinical as opposed to a case report can weigh favorably towards a higher star rating. Study results which are significant as opposed to non-significant can weigh favorably towards a higher star rating. Study center at university where the primary author is affiliated with a reputable university, as determined by analysis engine 125 of program 110, can weigh favorably towards a higher star rating.

Using the rating system to assess and determine the CRQIA score of a product, the 0 star rating is ascribed to non-rated products; the 1 star rating is ascribed to a minimal rated product; the 2 star rating is ascribed to a low rated product; the 3 star rating is ascribed to a moderately rated product; the 4 star rating is ascribed to a broadly related product; and the 5 star rating is ascribed to the highly rated product.

### Example 3—Search Criteria

Analysis engine 125 can receive search query terms and process the search queries on the criteria below. Clinical studies search criteria include: Home page for the product (for available scientific data); Google searches by product name, product name plus research, or product name plus studies; Google scholar search by product name, product name plus research, or product name plus studies.

### Example 4—Output

FIG. 8 is a pictorial depiction 800 of a CRQIA score, a research quality score, and rating. This output is the result of the database being mined for product descriptors, essentially the 10 questions being answered and being awarded numerical values. The pictorial depiction 800 is an example of what a user can see on a website or mobile application. The pictorial depiction 800 can take on different forms, such as the star rating for the rating, and odometers for the CRQIA score and research quality scores. Any visually appealing depiction of the CRQUIA score, research quality score, and rating is possible.

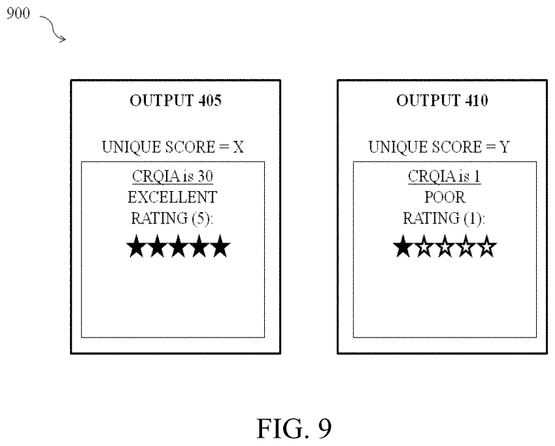

FIG. 9 is an alternative visual depiction 900 of the research quality score, CRQIA score, and rating. The alternative visual depiction 900 is what would appear on a website or mobile application. Output 405 shows an excellent score, CRQIA of 30, and a rating of 5 stars. Output 410 shows a poor score, CRQIA of 1, and a rating of 1 star. The alternative visual depiction 900 can take on other visually appealing and readily apparent depictions of the research quality score, CRQIA, and rating. In the alternative visual depiction 900, the rating is shown as stars, but numerical values or any symbols that demonstrate numerical values are also acceptable.

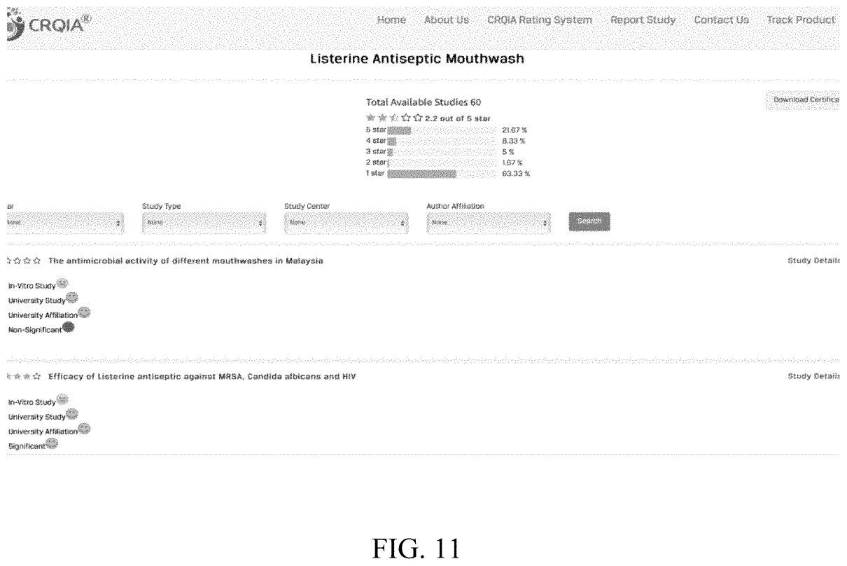

FIG. 11 depicts an output of CRQIA for Listerine Antiseptic Mouthwash, where there are 60 available studies from databases 140A-C and the rating is 2.2 stars out of 5 stars. The categories, as described above, are used by program 110 to generate the rating for the product and each reference. In the study entitled “The antimicrobial activity of different mouthwashes in Malaysia”, the study type is in-vitro and given a neutral face (which does not increase or decrease the rating). The study center and affiliation are a university and given a happy face (which increases the rating). The study results are non-significant and given a sad face (which decreases the rating). While there more happy faces than sad faces, the sad face for the study results has the most impact on the rating, which is negative, for the study entitled “The antimicrobial activity of different mouthwashes in Malaysia.” Accordingly, the “The antimicrobial activity of different mouthwashes in Malaysia” is given 1 star out of 5 stars. In the study entitled, “Efficacy of Listerine antiseptic against MRSA, Candida-albicans and HIV”, the study type is in-vitro and given a neutral face (which does not increase or decrease the rating). The study center and affiliation are a university and given a happy face (which increases the rating). The study results are significant and given a happy face (which increases the rating). The happy face for the study results weighs in favor of increasing the rating for study entitled, “Efficacy of Listerine antiseptic against MRSA, Candida-albicans and HIV.” Accordingly, this study is given 4 stars instead of 1 star for the study entitled “The antimicrobial activity of different mouthwashes in Malaysia” by program 110.

As also depicted in FIG. 11, the studies depicted in the GUI, such as UI 105, can be sorted based on the four categories. Analysis engine 125 can apply different categories and values of the categories when generating a rating for assessing the quality of research of a product.

### OTHER EMBODIMENTS

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical applications, or technical improvement over technologies found in the marketplace, or to enable others of ordinary skill in the art to understand the embodiments disclosed herein.

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. Any equivalent embodiments are intended to be within the scope of this invention. Indeed, various modifications of the invention in addition to those shown and described herein will become apparent to those skilled in the art from the foregoing description which does not depart from the spirit or scope of the present inventive discovery. Such modifications are also intended to fall within the scope of the appended claims.

### REFERENCES CITED

All publications, patents, patent applications and other references cited in this application are incorporated herein by reference in their entirety for all purposes to the same extent as if each individual publication, patent, patent application or other reference was specifically and individually indicated to be incorporated by reference in its entirety for all purposes. Citation of a reference herein shall not be construed as an admission that such is prior art to the present invention.

What is claimed is:

1. A method for assessing quality of research, the method comprising:
receiving data into a computing device;
accessing a database, wherein the database contains documentation associated with the data;
applying an algorithm to the database and thereby mining the database for product descriptors associated with the data;
comparing the data to at least a first standard; and
generating a unique score based on the data, wherein the unique score is outputted to a graphical user interface of the computing device.

2. The method of claim 1, wherein the database comprises journal articles, abstracts, clinical research papers, white papers, case studies, and combinations thereof.

3. The method of claim 1, wherein the unique score comprises a clinical research quality index analysis (CRQIA) score ranging from 1-30, a research quality score, and a rating from 0-5, with the product descriptors being at least one of study type, study center, principal author affiliation, number of subjects enrolled, positive control, negative control, study duration, number of investigators, number of centers involved, and study protocol.

4. The method of claim 1, wherein the product descriptors are one of: study type, study center, principal author affiliation, number of subjects enrolled, positive control, negative control, study duration, number of investigators, number of centers involved, and study protocol.

5. The method of claim 1, wherein applying the algorithm comprises:
comparing the database to the first standard and a second standard; and
applying a plurality of questions to the database, the first standard, and the second standard.

6. The method of claim 1, further comprising a server connecting to a website accessing the database and a mobile application on the computer device, with the database incorporating publications that update the unique score.

7. The method of claim 1, wherein the database incorporates publications, updating the unique score.

8. The method of claim 5, wherein at least one of a user and a company upload contents to at least one of the website and the mobile application, updating the unique score, with the unique score being sent to at least one of the user and the company in at least one of in real time and on delay, and with at least one of the CRQIA, the research quality score, and the rating being depicted pictorially.

9. The method of claim 6, wherein the unique score is sent to the user and the company in real-time.

10. The method of claim 6, wherein the unique score is sent to the user and the company on delay.

11. The method of claim 3, wherein the CRQIA, research quality score, and rating are depicted pictorially.

12. A system for assessing quality of research, the system comprising:
a server;
a computing device in communication with the server over a network, the computing device including a processor and a memory, the memory bearing computer executable code configured to perform the steps of:
receiving data into the computing device;
accessing a database, wherein the database contains documentation associated with the data;
applying an algorithm on the database and thereby mining the database for product descriptors associated with the data;
comparing the data to at least a first standard; and
generating a unique score based on the data, wherein the unique score is outputted to a graphical user interface of the computing device, with the database comprising journal articles, abstracts, clinical research papers, white papers, case studies, and combinations thereof.

13. The system of claim 12, wherein the database contains journal articles, abstracts, clinical research papers, white papers, case studies, and combinations thereof.

14. The system of claim 7, wherein the unique score comprises a clinical research quality index analysis (CRQIA) score ranging from 1-30, a research quality score, and a rating from 0-5, with the product descriptors being at least one of study type, study center, principal author affiliation, number of subjects enrolled, positive control, negative control, study duration, parameter assessed, number of investigators, number of centers involved, and study protocol.

15. The system of claim 12, wherein the product descriptors are at least one of: study type, study center, principal author affiliation, number of subjects enrolled, positive control, negative control, study duration, parameter assessed, number of investigators, number of centers involved, and study protocol.

16. The system of claim 7, wherein applying the algorithm comprises:
comparing the database to the first standard and a second standard; and
applying a plurality of questions on the database, the first standard, and the second standard.

17. The system of claim 7, wherein the server connects a website accessing the database and a mobile application on the computer device, with the database incorporating publications that update the unique score.

18. The system of claim 12, wherein the database incorporates publications, updating the unique score.

19. The system of claim 10, wherein the website and the mobile application receives contents from a user and a company, thereby updating the unique score, with the unique score being sent to at least one of the user and the company in at least one of in real time and on delay.

20. The system of claim 19, wherein the unique score is sent to the user and the company in real-time.

21. The system of claim 19, wherein the unique score is sent to the user and the company on delay.

22. The system of claim 7, wherein database derive contents therein from a search engine, scientific literature, patent literature, product websites, company websites, and combinations thereof.

23. A computer program product for assessing quality of research comprising computer executable code embodied in a non-transitory computer readable medium that, when executing on one or more computing devices, performs steps of:
receiving data into the computing device;
accessing a database, wherein the database contains documentation associated with the data;
applying an algorithm on the database and thereby mining the database for product descriptors associated with the data;
comparing the data to at least a first standard; and
generating a unique score based on the data, wherein the unique score is outputted to a graphical user interface of the computing device.

24. The computer program product of claim 13, wherein the database contains journal articles, abstracts, clinical research papers, white papers, case studies, and combinations thereof.

25. The computer program product of claim 13, wherein the unique score comprises a clinical research quality index analysis (CRQIA) ranging from 1-30, a research quality score, and a rating from 0-5, with the product descriptors comprising at least one of: study type, study center, principal author affiliation, number of subjects enrolled, positive control, negative control, study duration, parameter assessed, number of investigators, number of centers involved, and study protocol.

26. The computer program product of claim 23, wherein the product descriptors are at least one of: study type, study center, principal author affiliation, number of subjects enrolled, positive control, negative control, study duration, parameter assessed, number of investigators, number of centers involved, and study protocol.

27. The computer program product of claim 13, wherein applying the algorithm comprises:
comparing the database to the first standard and a second standard; and
applying a plurality of questions on the database, the first standard, and the second standard.

28. The computer program product of claim 13, wherein a server connects a website accessing the database and a mobile application on the computer device, with the database incorporating publications, updating the unique score.

29. The computer program product of claim 23, wherein the database incorporates publications, updating the unique score.

30. The computer program product of claim 17, wherein the web site and the mobile application receive contents uploaded from a user and a company, thereby updating the unique score.

31. The computer program product of claim 18, wherein the unique score is sent to the user and the company in at least one of in real-time and on delay.

32. The computer program product of claim 28, wherein the unique score is sent to the user and the company on delay.

33. The computer program product of claim 13, wherein contents of the database are derived from one of a search engine, scientific literature, patent literature, product web sites, company web sites, and combinations thereof.
